(19) United States
(12) Patent Application Publication
(10) Pub. No.: US 2006/0149650 A1
(43) Pub. Date: Jul. 6, 2006

(54) Fundraiser system

(76) Inventor: James Kevin Dilley, Mount Juliet, TN (US)

Correspondence Address: JAMES ADDISON BARRY, JR., 105 GLENWAY POINT, LEBANON, TN, 37087, US

(21) Appl. No.: 11/029,315

(22) Filed: Jan. 5, 2005

(51) Int. Cl. G06Q 40/00

(52) U.S. Cl. 705/35

(57) ABSTRACT

A system and method of fundraising that links a donor 106 and a fundraiser client 104 for a fundraising activity. The fundraising system 100 comprises an interface 110, a client computer link 120, a fundraising template 130, a donor computer link 140, and a processing means 150 that initiates the accounts, processes the transactions, determines the end of the fundraising session, notifies the parties, and disburses the funds. The donation may be in the form multiple online activities. The fundraising template 130 allows the client 104 to personalize their interface 110 and generate a web page or other electronic interface page customized for the individual fundraiser.

### FIELD OF THE INVENTION

The present invention relates to a system and method for conducting fundraising activities.

### BACKGROUND OF THE INVENTION

Charitable and other non-profit organizations often raise money through fundraising. These organizations utilize various well-known methods to establish contact with potential donors that often lead a potential donor to make a contribution to the organizations. There are many fundraising activities available including candy sales, white elephant sales or auctions, raffles, car washes, bake sales, magazine sales, and catalog sales. Professional fundraisers and contract fundraisers are available to help organizations raise money, typically for nonprofit activities. The fundraising takes place door to door, and at schools, churches, work, and online. Ordinarily, the organization will make only 40 to 50 cents on the dollar after expenses associated with the fundraising activity are deducted. Primarily, the markets for these fundraising activities are schools, municipalities, churches, organizations, sporting teams, and leagues.

In recent years, financial transactions over the Internet or the World Wide Web have become common. The use of credit cards and other financial instruments on the Internet has become sufficiently secure so that there is less reluctance to engage in such transactions by the average consumer.

Published U.S. patent applications Ser. No. 2002/0091538, A Method and System for an Efficient Fundraising Campaign over a Wide Area Network; 2002/0073026, A Method and System for Interactive Fundraising over a Wide Area Network; and 2002/0029179, A Method and System for Interactive Fundraising over a Wide Area Network teach using the internet system for fundraising. However, these applications fail to provide an interface and template that provides a customized fundraiser web page with personalized design options for multiple types of fundraising.

It would be desirable to have a fundraising system that: operates as an income generating site; provides multiple online fundraising activities; provides ease of use in site navigation, with clear help and frequently asked questions; functions for both the adult donor or the child/group/organization user; brings together the fundraiser, fundraising entity, and the fund provider in a unique method of generating funds; creates a safe environment for fundraising, quick turnaround in fund collections, with an accountable process to reconcile fundraising activities; provides a low-cost, high-income generating activity compared to traditional fundraising activities; and provides a web page with customized design options where advertising coupon discounts may be provided to the fundraiser.

### SUMMARY OF THE INVENTION

The present invention provides a fundraising system that: operates as an income generating site; provides multiple online fundraising activities; provides ease of use in site navigation, with clear help and frequently asked questions; functions for both the adult donor or the child/group/organization user; brings together the fundraiser, fundraising entity, and the fund provider in a unique method of generating funds; creates a safe environment for fundraising, quick turnaround in fund collections, with an accountable process to reconcile fundraising activities; provides a low-cost, high-income generating activity compared to traditional fundraising activities; and provides a web page with customized design options where advertising coupon discounts may be provided to the fundraiser.

One embodiment of the present invention provides a fundraising system for linking a donor and a fundraiser client for a fundraising activity via a computer network. The fundraising system comprises an interface; a client computer link, that links the client to the interface; a fundraising template connected with the client computer link and the interface allowing the client to personalize the interface; a donor computer link, that links the donor to the interface; and a processing means connected with the interface, wherein the processing means initiates the account of the fundraising client, processes donor transactions, determines an end of the fundraising session, notifies designated parties and disburses funds. Another embodiment of the present invention may include a processing means to process direct donations to the fundraising client. A further embodiment of the present invention may include a processing means that initiates a raffle account for the fundraiser client wherein a winner is electronically selected at the end of the fundraising session. Another embodiment of the present invention may include a processing means that initiates an auction account for the fundraiser client wherein a winner is electronically determined at the end of the fundraising session period. Other embodiments of the present invention include a web-link to allow the donor to view information about the fundraising activity, a display to review the fundraising activity for the fundraiser client, and a means to compute incentive options for the fundraiser client. Yet another embodiment of the present invention may further include additional processing means for: initiating banner advertising for generating additional income for the fundraiser client or the fundraiser system; providing interactive activities for generating additional traffic to the fundraiser site; and providing options for controlled access of fundraising clients for maintaining the integrity of the fundraising client. Embodiments of the present invention may also include further processing means providing options for direct mailing to a potential donor without internet access and options for printing tax receipts for the donor.

Another embodiment of the present invention provides a method of linking a donor and a fundraiser client via a computer network with an interface for a fundraising activity. The method comprises the steps of linking the fundraiser client to the interface with a client computer link; personalizing the interface with a fundraising template allowing the fundraiser to add custom features to the interface; linking the donor to the interface with a donor computer link; processing including initiating the fundraising client's account; processing the donor transactions; determining the end of the fundraising session; notifying the designated parties; and disbursing the funds to designated parties. Other embodiments of the present invention may also include steps of linking the donor to information about the fundraising activity with a web link; processing donor transactions that are direct donations to the fundraising client; initiating a raffle account for the fundraiser client; selecting a winner of the raffle at the end of the fundraising session; initiating an auction account for the fundraiser client; determining a winner of the auction at the end of the fundraising session; displaying a review of fundraising activities for the client through the interface; and computing incentive options for the fundraising client. Further embodiments of the present invention may also comprise the steps of providing banner advertising during the fundraising session to generate extra income; providing an interactive page to generate additional traffic to the fundraiser site; and providing controlled access to fundraising clients for maintaining the integrity of the fundraising client.

Another embodiment of the present invention provides a machine readable medium having stored thereon data comprising sequences of instructions which when executed by a computer system provides for linking a donor and a fundraiser client via a computer network with an interface for a fundraising activity. The computer system connected to a computer network cause the computer system to perform the steps of linking the fundraiser client to the interface with a client computer link; personalizing the interface with a fundraising template allowing the fundraiser to add custom features to the interface; linking the donor to the interface with a donor computer link; initiating the fundraising client's account; processing the donor transactions; determining the end of the fundraising session; notifying the designated parties; and disbursing the funds to designated parties. Yet another embodiment of the present invention provides a machine readable medium further comprising sequences of instructions which when executed by a computer system further causing the computer system to perform the steps of linking the donor to information about the fundraising activity with a web link; processing donor transactions that are direct donations to the fundraising client; initiating a raffle account for the fundraiser client; selecting a winner of the raffle at the end of the fundraising session; initiating an auction account for the fundraiser client; determining a winner of the auction at the end of the fundraising session; displaying a review of fundraising activities for the client through the interface; and computing incentive options for the fundraising client. Still another embodiment of the present invention provides a machine readable medium further causing the computer system to perform the steps of providing banner advertising during the fundraising session to generate extra income; providing an interactive page to generate additional traffic to the fundraiser site; and providing controlled access to fundraising clients for maintaining the integrity of the fundraising client.

### BRIEF DESCRIPTION OF THE DRAWINGS

These and other features, aspects, and advantages of the invention will become better understood with regard to the following description, appended claims, and accompanying drawings where:

FIG. 1 is a block diagram depicting a fundraising system according to the present invention;

FIG. 2 is a block diagram depicting a processing means according to the present invention;

FIG. 3 is a block diagram illustrating a client interface page according to the present invention;

FIG. 4 is a block diagram illustrating a donor interface page according to the present invention; and

FIG. 5 is a flow diagram of the steps for linking the donor and the fundraiser according to the present invention.

### DETAILED DESCRIPTION OF THE INVENTION

The present invention relates to the field of fundraising systems and methods. More specifically, this disclosure presents a fundraising system and method for generating funds for fundraising entities. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purpose of this discussion, a fundraiser client refers to a person or an organization soliciting a potential donor or an organization for a charitable donation. The fundraiser client may be a volunteer, an agent or an employee of a charitable, nonprofit or other organization. The fundraiser client may be a commercial fundraiser or an agent or employee thereof engaged for the purpose of assisting a charitable or other organization in its fundraising campaign. The fundraiser client may have multiple divisions or tiers of fundraisers within the organization. For example, a fundraiser client may be a school with several different grades and within the grade levels several different classes and within the classes several different students. The fundraiser client may be described as a user, host, or fundraiser. A donor refers to a person or an organization that makes a charitable donation. Also for the purpose of this discussion, a process or method is generally conceived to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, terms, numbers, records, files or the like. It should be kept in mind, however, that these and some other terms should be associated with appropriate physical quantities for computer operations and that these terms are merely conventional labels applied to physical quantities that exist within and during operation of the computer.

Overview of the Invention:

The present invention is a fundraising system and method. The fundraising system broadens the contribution base, generates increased collection of funds, speeds up collections, and eliminates difficult volunteer coordination. In one embodiment, the fundraising system may operate as an income generating internet site; provide multiple online fundraising activities such as donations, raffles, and auctions as a primary means to generate income; provide ease of use in site navigation, with clear help and frequently asked questions; functions for both the adult donor or the child/group/organization user; bring together the fundraiser, fundraising entity, and the fund provider in a unique method of generating funds; create a safe environment for fundraising, quick turnaround in fund collections, with an accountable process to reconcile fundraising activities; provide a low-cost, high-income generating activity compared to traditional fundraising activities; and provides a web page with customized design options where advertising coupon discounts may be provided to the fundraiser. The fundraising template allows a person to input pictures and video to customize the web page for the individual fundraiser. The income and revenue generating markets include but are not limited to: schools; school raffles; school sales; school auctions; municipalities; municipality raffles; municipality sales; municipality memorials; churches; church raffles; church sales; sporting team leagues; organizations; organization raffles; organization auctions; local establishments as advertising vehicles; and local establishments as coupon vehicles. The web page with customized design options of the template lowers the development costs of web page design, and internet data base design. It also expedites market entry for fundraising activities such as general fundraisers, raffles, auctions, and sales events.

Design Specifications:

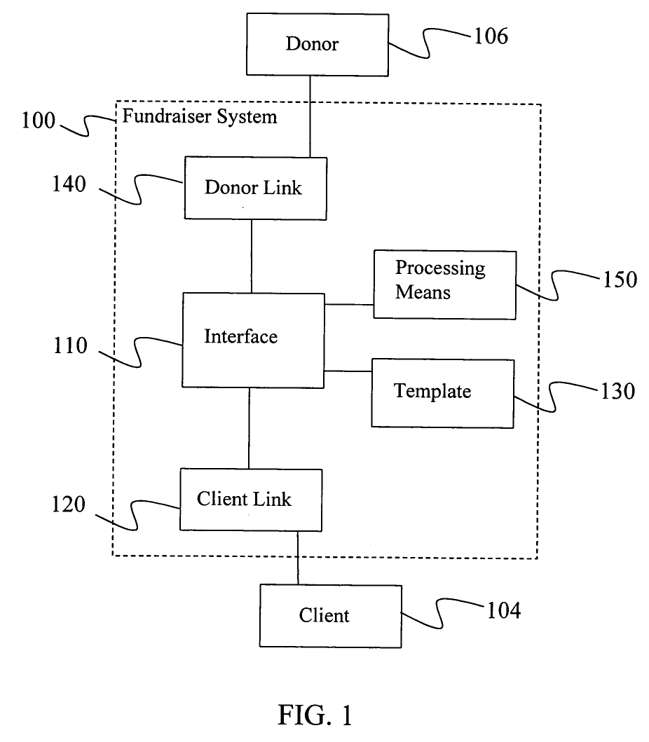

As depicted in FIG. 1, the fundraising system 100 is a means for linking a fundraiser client 104 and a donor 106 using a computer network to accomplish a fundraising activity. The fundraising system 100 consists of an interface 110, a client computer link 120, a fundraising template 130, a donor computer link 140, and a processing means 150. The interface 110 is a point of data communication between the client computer link 120, the processing means 150, the fundraising template 130, and the donor computer link 140. The client computer link 120 links the client 104 to the interface 110 so that the client 104 may use a computer network to review the procedures and benefits for using the fundraising system 100, open an account, set up a personalized interface, and view the progress of the fundraising activity.

The fundraising template 130 may be connected with the interface 110 and allows the client 104 to personalize their interface 110. The fundraising template 130 may generate a web page or other electronic interface page customized for the individual fundraiser. This template 130 allows the client 104 to add pictures or video to the page so potential donors may view where their donations are going and how they will be used. The template 130 may also allow for the custom design of the page itself to show logos, and other information that would be applicable to the specific fundraiser client 104. The host, fundraising group, or individual within the group may choose the look and feel of the specific template that might be used in their fundraising activity. The template 130 may allow the fundraiser client 104 to select from a choice of fundraising activities including, but not limited to, direct donations, raffle of an item, and auction of an item.

The donor computer link 140 establishes a connection between the donor 106 and the fundraiser system 100 interface 110. With this donor link 140 the donor 106 may view the web page or electronic interface page to decide if they would like to donate funds for the cause. The donor 106 may also use a web link to view other web sites that may give the donor 106 further information concerning items such as raffle or auction items.

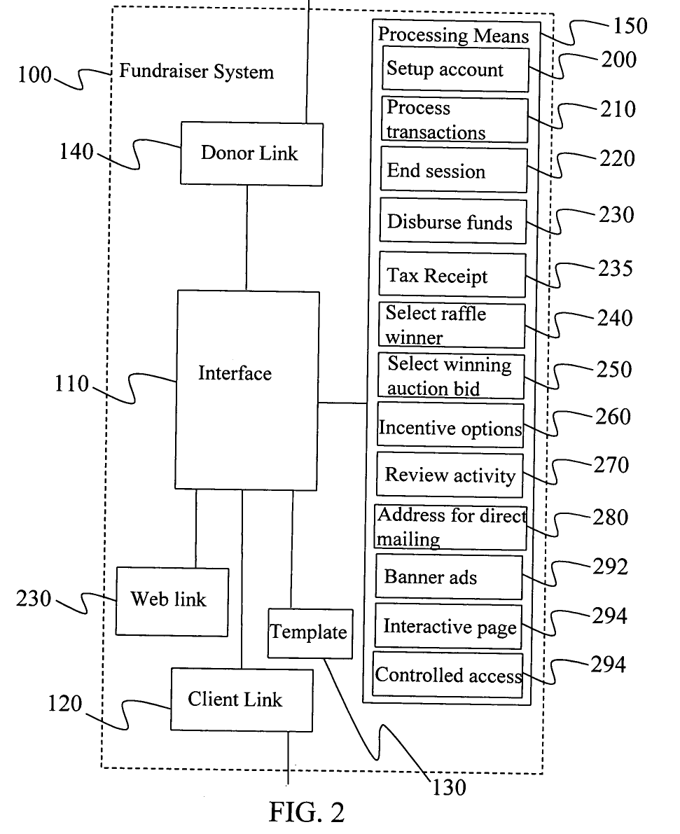

The processing means 150 is connected with the interface 110. As depicted in FIG. 2, the processing means 150 may initiate and setup a fundraising client's account 200, as well as process the donor transactions 210. The fundraiser client submits a request for approval of the use of the template, providing specific information that qualify the individual as a not for profit organization. Once the appropriate information has been submitted, an access code may be granted to the organization to begin hosting a fundraising event or activity. Since funds are electronically managed, the appropriate financial institution or bank routing information is also required. The donor transactions 210 may be a variety of transactions including but not limited to direct donations, purchasing a raffle chance for a particular item, or bidding on an item in an auction type of activity. The processing means 150 may also determine when the end of the fundraising session 220 has been reached as set by the fundraiser client; and then notifies the designated parties that should be notified, for example: the fundraising client, the winners of raffles and auctions, and a manager of the fundraiser system 100. The processing means 150 may also disburse funds 230 as well as items awarded, bought, or won. The processing means 150 may print tax receipts 235 for the donor's records. The processing means 150 may be programmed to electronically select the winner of a raffle 240 or determine the highest bidder 250 of an auctioned item. Incentive options 260 may also be computed by the processing means 150. The fundraiser may have the option of or exposure to incentives for fundraising with the fundraising system and method. The option or exposure may include but not be limited to coupons, prizes, goods, and services. Examples of options or exposure examples are: coupons from partner companies that utilize banner advertising, gift catalog offerings for fundraiser or donor associated with redemption points or values accumulated during fundraising activities, prizes for top performing fundraising individuals or groups, rewards or incentives donated by partner companies to the host, prize drawings for fundraising participants, and items donated by partner companies that may be used in raffles or auctions. The processing means 150 may display through the interface a review of the fundraising activity 270 for the fundraiser client. The review of activity 270 may be one or more reviews selected from the group that consists of: a review of the donors, a review of the donors by the amount of the donations given, a review of the results of the fundraiser group, a review of the fundraiser groups by divisions, a review of the fundraiser groups by amount of donations, and a review of the fundraiser group by overall cumulative group effort. Some donors and some fundraisers within the fundraising group may not have access to email, internet service, or computer service to access the fundraiser system 100. As an example, the fundraiser system 100 provides access to donors by accepting addresses of potential donors and generating a direct mailing 280 with information provided to the donor in the direct mailing 280 option. The fundraiser system 100 may also provide banner advertising with partner programs. These programs may consist of e coupons. The e coupons are printable coupons that are redeemable from a business that partners with the fundraising system 100. As the donor 106 responds to banner advertising for coupons, the business may pay for hits to the web site, or for use of the banners or pop ups. A percent of the additional income generated from this advertising may go to the fundraising client or to the fundraising system 100 or to both. An interactive fundraiser option 294 may be provided for fundraisers in the fundraiser group. The interactive fundraiser option 294 is a perk to generate internet traffic to the site. This acts as a promotion or motivation to increase the use of the fundraiser page. One example of the interactive fundraiser option 294 may include games or a fun section for youth. The youth might pick from different games such as mazes, tic-tac-toe, card games, or crossword puzzles. This allows both the host fundraiser and the members of the fundraiser group to customize the look and feel of the web page. At times a school, church, or sporting team may desire to maintain a certain image and desire to control the access to all fundraiser page developments to insure the integrity of the image desired by the host fundraiser. The processing means 150 additionally may provide options for controlled access of fundraising clients for maintaining the integrity of the fundraising client. The controlled access of fundraisers 297 will allow the host fundraiser to restrict the fundraisers within the group to certain members within the group. The controlled access of fundraisers 297 would also allow a host fundraiser to have a closed fundraiser and limit the fundraiser pages to members of the fundraiser organization as opposed to an open fundraiser where members of the fundraising organization could recruit fundraisers outside the organization to help in raising funds. The fundraising client will assign fundraising participants by providing an access code. When the fundraising participants enter the site they will be required to set up a secure site by creating an individual password.

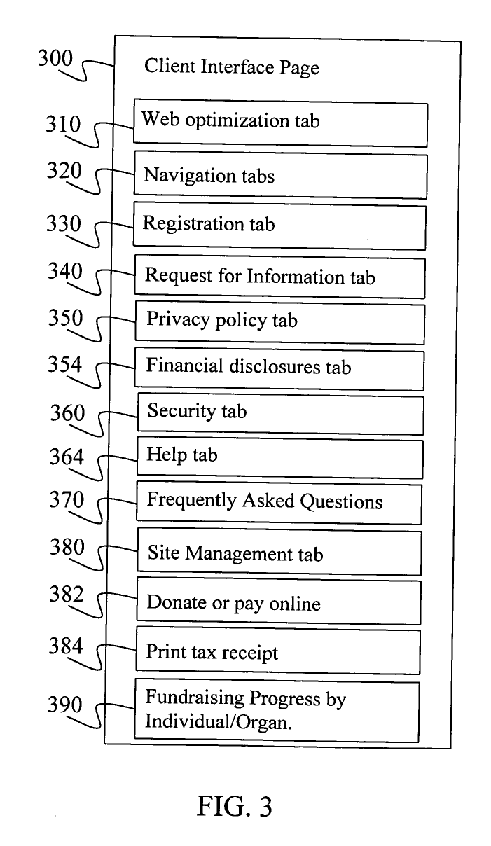

The client's interface page 300 as illustrated in FIG. 3 may contain a web optimizer 30 tab 310. The web optimizer tab 310 provides for maximizing fundraising by providing suggestions and direction on web optimization and market penetration. Navigation tabs 320 may provide for ease of navigation within the site. A registration tab 330 may be used by the primary fundraiser for setup. A request for information tab 340 may provide current information concerning the fundraisers. There may also be a privacy policy tab 350; a financial disclosures tab 354; a security tab 360; a help tab 364; and a FAQ-frequently asked questions tab 370. A site management tab 380 may be available that allows for fundraising control of the client's interface page 300 for the fundraising organization or entity; as well as an ability to donate or pay online for contributions or fund collections 382; an ability to print tax receipt for personal or business tax purposes 384; and a list of top fundraising individuals and organizations by category 390.

The organization or entity control page, the fundraiser client's interface page 300, may display the fundraising progress by an individual or organization 390. The fundraising progress display 390 may include but is not limited to: a listing of all participants; an ability to pull up each participant individually or roll-up information by groupings such as class, team, department, division, etc.; an overall fundraising goal that shows total progress or progress from one group to another if a competitive fundraising activity; electronic verification of fundraiser that breaks all donations down by fundraising individual.

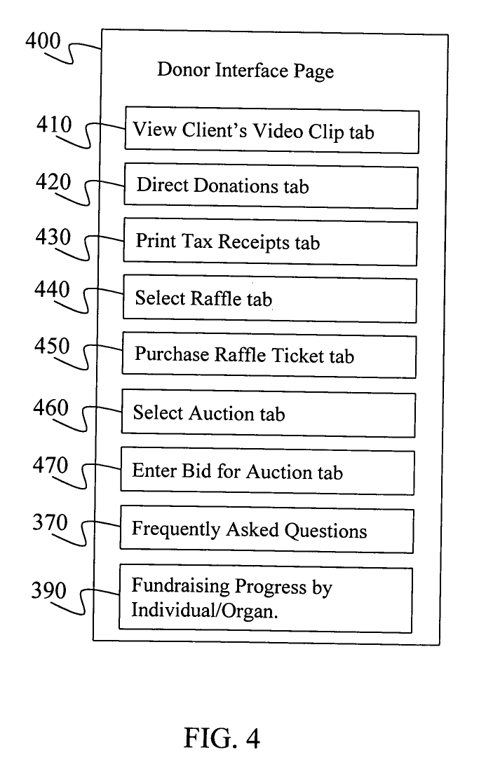

The donor's interface page 400 as illustrated in FIG. 4 may contain a view client's video clip tab 410 to view the fundraiser client's video or audio clip; a direct donations tab 420 for making direct donations to the fundraiser or charity; a print tax receipts tab 430 for printing tax receipts for personal or business tax purposes; a select raffle tab 440 for entering the raffle mode to view information on the raffle item; a purchase raffle tickets tab 450; a select auction item tab 460; an enter bid for auction item tab 470; a FAQ-frequently asked questions tab 370; and a list of top fundraising individuals and organizations by category 390.

The flow of funds may be generated by an online payment via a secure online transaction means. The funds may be placed in an escrow account during the fundraising period for later distribution to the organization. The flow of funds may also be tracked by an individual and/or an organization. In addition, detailed information is available for fundraising overview and activity. At the conclusion of the activity, the fundraising account may be reconciled and disbursed to the organization via online transfer or deposit into the respective account. The amount of funds agreed upon may be distributed to the fundraiser or the system manager.

Manner of use:

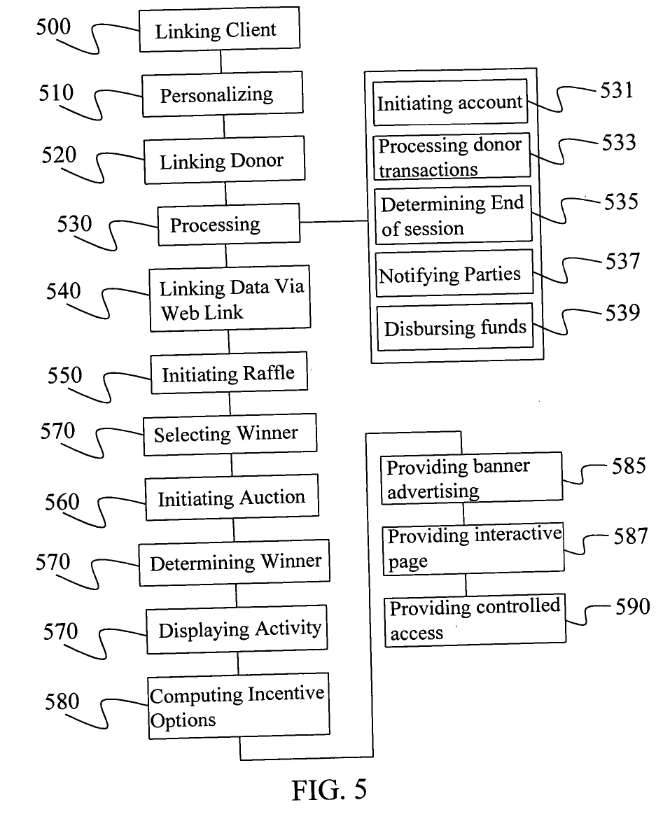

As representatively shown in FIG. 5, the present invention includes a method of linking a donor and a fundraiser client via a computer network with an interface for a fundraising activity. The method comprises the steps of linking the fundraiser client 500 to the interface using a client computer link. Another step of personalizing the interface 510 with a fundraising template allows the fundraiser to add custom features to the interface. The step of linking the donor to the interface 520 with a donor computer link is useful for connecting the donor to the fundraising system. The donor may have received an email with a link to the site; the donor may have received a note, flyer, or brochure with the name of the website listed; or the donor may find the website via a search engine. A step of processing 530 includes initiating the account 531 for activating or setting up the account of the fundraising client. Another step of processing 530 includes processing the donor transactions 533. This step allows the donor to contribute to the fundraiser client via a secured transaction over the computer network. At the time designated by the fundraising client, another step of processing 530 includes determining the end of the fundraising session 535. A further step of processing 530 includes notifying the designated parties 537. This step takes place at the end of the fundraising session. The parties are designated by the fundraising client and the fundraising system and may include the fundraising client, the manager of the fundraising system, the winners of any raffle items and the winners of any auction items. The processing step of disbursing the funds to the designated parties 539 distributes the funds as agreed upon with the fundraising system. Other steps may include: linking data information via a web link 540; processing donor transactions 533 wherein the donor transactions are direct donations to the fundraising client; a step of initiating a raffle process 550 and a step of selecting a winner of the raffle item 545; a step of initiating an auction 560 may be included as well as a step of determining the winner of the auction item 565. A step of displaying activity 570 may also included where different fundraising activities may be reviewed. The displaying of activity step 570 may be one or more reviews selected from the group that consists of: a review of the donors, a review of the donors by the amount of the donations given, a review of the results of the fundraiser group, a review of the fundraiser groups by divisions, a review of the fundraiser groups by amount of donations, and a review of the fundraiser group by overall cumulative group effort. A further step of computing incentive options 580 may also be included. Other embodiments may comprise further steps of: providing banner advertising 585 during the fundraising session to generate extra income; providing an interactive page 587 to generate additional traffic to the fundraiser site; and providing controlled access 590 to fundraising client for maintaining the integrity of the fundraising client. Providing banner advertising 585 may consist of e coupons. The e coupons are printable coupons that are redeemable from a business that partners with the fundraiser with a percent of the additional income generated from this advertising may going to the fundraising client or to the fundraising system or to both. Providing an interactive page 587 is a perk to generate internet traffic to the site. This acts as a promotion or motivation to increase the use of the fundraiser page. One example of the interactive fundraiser option 294 may include games or a fun section for youth. The youth might pick from different games such as mazes, tic-tac-toe, card games, or crossword puzzles. Providing controlled access 590 will allow the host fundraiser to restrict the fundraisers within the group to certain members within the group. The controlled access will also allow a host fundraiser to have a closed fundraiser and limit the fundraiser pages to members of the fundraiser organization as opposed to an open fundraiser where members of the fundraising organization could recruit fundraisers outside the organization to help in raising funds.

In one embodiment of the present invention, a machine readable medium has stored thereon data representing sequences of instructions which when executed by a computer system provides for linking a donor and a fundraiser client via a computer network with an interface for a fundraising activity, the computer system connected to a computer network cause the computer system to perform the steps of linking the fundraiser client to the interface with a client computer link; personalizing the interface with a fundraising template allowing the fundraiser to add custom features to the interface; linking the donor to the interface with a donor computer link; initiating the account of the fundraising client; processing the donor transactions; determining the end of the fundraising session; notifying the designated parties; and disbursing the funds to designated parties. In another embodiment of the present invention, the machine readable medium further causes the computer system to perform the steps of linking the donor to information about the fundraising activity with a web link; processing donor transactions that are direct donations to the fundraising client; initiating a raffle account for the fundraiser client; selecting a winner of the raffle at the end of the fundraising session; initiating an auction account for the fundraiser client; determining a winner of the auction at the end of the fundraising session; displaying a review of fundraising activities for the client through the interface; and computing incentive options for the fundraising client. In yet another embodiment of the present invention, the machine readable medium further causes the computer system to perform the steps of providing banner advertising during the fundraising session to generate extra income; providing an interactive page to generate additional traffic to the fundraiser site; and providing controlled access to fundraising clients for maintaining the integrity of the fundraising client.

Uniqueness:

As depicted in FIG. 2, the uniqueness of this invention is illustrated in many ways, five of which are as follows. First, the design of the system provides an interface and template that provides a customized web page with personalized design options. Second, the design of the system provides an income generating site for fundraising that may provide multiple online fundraising activities. Third, the system creates a safe secure environment for the transfer of donations and funds. Fourth, the simplicity of the system provides ease of use in site navigation with multiple tabs for fundraiser client and donor use. Fifth, the system brings together the fundraiser, fundraising entity, and the fund provider in a unique method of generating funds to provide a low-cost, high-income generating activity compared to traditional fundraising activities.

What is claimed is:

1. A fundraising system for linking a donor and a fundraiser client for a fundraising activity via a computer network, the fundraising system comprising:
an interface;
a client computer link, that links the client to the interface;
a fundraising template connected with the client computer link through the interface allowing the client to personalize the interface;
a donor computer link, that links the donor to the interface; and
a processing means connected with the interface, wherein the processing means initiates an account of the fundraising client, processes donor transactions, determines
an end of the fundraising session, notifies designated parties and disburses funds.

2. A fundraising system as set forth in claim 1, wherein the processing means processes donor transactions that are direct donations to the fundraising client.

3. A fundraising system as set forth in claim 1, wherein the processing means initiates a raffle account for the fundraiser client wherein a winner is electronically selected at the end of the fundraising session period.

4. A fundraising system as set forth in claim 1, wherein the processing means initiates an auction account for the fundraiser client wherein a winner is electronically determined at the end of the fundraising session period.

5. A fundraising system as set forth in claim 1, wherein the interface comprises a web-link to allow the donor to view information about the fundraising activity.

6. A fundraising system as set forth in claim 1, wherein the processing means displays, through the interface, a review of the fundraising activity for the fundraiser client.

7. A fundraising system as set forth in claim 6, wherein the processing means further displays, through the interface, at least one review of the fundraising activity for the fundraiser client wherein the at least one review is selected from the group consisting of a review of the donors, a review of the donors by amount of donations, a review of a fundraiser group, a review of the fundraiser group by divisions, a review of the fundraiser group by amount of donations, and a review of the fundraiser group by overall cumulative group effort.

8. A fundraising system as set forth in claim 1, wherein the processing means computes incentive options for the fundraiser client.

9. A fundraising system as set forth in claim 1, wherein the processing means initiates banner advertising for generating additional income for the fundraiser client.

10. A fundraising system as set forth in claim 1, wherein the processing means initiates banner advertising for generating additional income for the fundraiser system.

11. A fundraising system as set forth in claim 1, wherein the processing means provides interactive activities for generating additional traffic to the fundraiser site.

12. A fundraising system as set forth in claim 1, wherein the processing means provides options for controlled access of fundraising clients for maintaining the integrity of the fundraising client.

13. A fundraising system as set forth in claim 1, wherein the processing means provides options for direct mailing to a potential donor without internet access.

14. A fundraising system as set forth in claim 1, wherein the processing means provides options for printing tax receipts for donor.

15. A fundraising system as set forth in claim 1, wherein the interface comprises a web link to allow the donor to view information about the fundraising activity; and wherein the processing means further: processes donor transactions that are direct donations to the fundraising client; initiates a raffle account for the fundraiser client wherein a winner is electronically selected at the end of the fundraising session period; initiates an auction account for the fundraiser client wherein a winner is electronically determined at the end of the fundraising session period; displays, through the interface, a review of the fundraising activity for the client; initiates banner advertising for generating additional income for the fundraiser client; provides interactive activities for generating additional traffic to the fundraiser site; provides options for controlled access of fundraising clients for maintaining the integrity of the fundraising client; and computes incentive options for the fundraiser client.

16. A method of linking a donor and a fundraiser client via a computer network with an interface for a fundraising activity, the method comprising the steps of:
linking the fundraiser client to the interface with a client computer link;
personalizing the interface with a fundraising template allowing the fundraiser to add custom features to the interface;
linking the donor to the interface with a donor computer link;
processing comprising the steps of:
initiating the account of the fundraising client;
processing the donor transactions;
determining the end of the fundraising session;
notifying the designated parties; and
disbursing the funds to designated parties.

17. A method as set forth in claim 16, further comprising the steps of:
linking the donor to information about the fundraising activity with a web link;
processing donor transactions that are direct donations to the fundraising client;
initiating a raffle account for the fundraiser client;
selecting a winner of the raffle at the end of the fundraising session;
initiating an auction account for the fundraiser client;
determining a winner of the auction at the end of the fundraising session;
displaying a review of fundraising activities for the client through the interface; and
computing incentive options for the fundraising client.

18. A method as set forth in claim 16, further comprising the steps of:
providing banner advertising during the fundraising session to generate extra income;
providing an interactive page to generate additional traffic to the fundraiser site; and
providing controlled access to fundraising clients for maintaining the integrity of the fundraising client.

19. A machine readable medium having stored thereon data representing sequences of instructions which when executed by a computer system provides for linking a donor and a fundraiser client via a computer network with an interface for a fundraising activity, the computer system connected to a computer network cause the computer system to perform the steps of:
linking the fundraiser client to the interface with a client computer link;
personalizing the interface with a fundraising template allowing the fundraiser to add custom features to the interface;
linking the donor to the interface with a donor computer link;
initiating the account of the fundraising client;
processing the donor transactions;
determining the end of the fundraising session;
notifying the designated parties; and
disbursing the funds to designated parties.

20. A machine readable medium as set forth in claim 19, further causing the computer system to perform the steps of:
linking the donor to information about the fundraising activity with a web link;
processing donor transactions that are direct donations to the fundraising client;
initiating a raffle account for the fundraiser client;
selecting a winner of the raffle at the end of the fundraising session;
initiating an auction account for the fundraiser client;
determining a winner of the auction at the end of the fundraising session;
displaying a review of fundraising activities for the client through the interface;
computing incentive options for the fundraising client;
providing banner advertising during the fundraising session to generate extra income;
providing an interactive page to generate additional traffic to the fundraiser site; and
providing controlled access to fundraising clients for maintaining the integrity of the fundraising client.
